(19) United States
(12) Patent Application Publication
(10) Pub. No.: US 2018/0170096 A1
(43) Pub. Date: Jun. 21, 2018

(54) ALLOY COMPOSITE ROAD WHEEL FOR A VEHICLE

(71) Applicant: SUPERIOR INDUSTRIES INTERNATIONAL, INC., SOUTHFIELD, MI (US)

(72) Inventors: Henry Clay Chenault, III, Fayettevile, AR (US); Parveen Kakar, Novi, MI (US)

(21) Appl. No.: 15/843,505

(22) Filed: Dec. 15, 2017

Related U.S. Application Data
(60) Provisional application No. 62/434,709, filed on Dec. 15, 2016.

(51) Int. Cl. B60B 1/14; B60B 5/02; B60B 7/00

(52) U.S. Cl. CPC B60B 1/14; B60B 5/02; B60B 7/00; B60B 2360/10; B60B 2360/3412; B60B 2360/3416; B60B 2900/111; B60B 2360/341

(57) ABSTRACT

A road wheel for a vehicle includes a central portion and a rim portion. The central portion defines a wheel axis and is formed from a first material. The central portion includes a plurality of spokes extending radially outwardly from a lug member defined by the central portion. Each of the spokes is interconnected to a link disposed at a distal end of the spokes. The rim portion is formed from a second material and defines a tubular wall being coaxial with the wheel axis. The rim portion including an interlock configured to receive the link for interconnecting the central portion with the rim portion.

### PRIOR APPLICATION

The present application claims priority to U.S. Provisional Patent Application No. 62/434,709 filed on Dec. 15, 2016, the contents of which are incorporated herein by reference.

### TECHNICAL FIELD

The present application relates generally toward a light weight composite road wheel for a vehicle. More specifically, the present invention relates toward a hybrid composite wheel making use of metallic alloys and polymeric composite materials.

### BACKGROUND

Cast alloy wheels have been in use on automobiles designed for road use and other vehicles designed for off-road use for many years. Cast alloys such as, for example, aluminum, magnesium and titanium have provided desirable appearance while also providing reduced mass over older steel wheels that include hubcaps for providing desirable appearance. Ever increasing fuel efficiency standards have put pressure on vehicle manufacturers to continuously reduce mass, even on vehicle components already providing low mass features, such as, for example, alloy wheels. It is believed that reducing mass of a wheel is more beneficial than reducing mass of other vehicle components because the energy required to rotate a wheel with a disadvantageous moment of inertia.

Some efforts have been made to reduce the mass of a vehicle wheel by forming all or part of the wheel from composite materials. Forming an entire wheel from a composite has proven too expensive for mass production given the complexity of forming spokes and lug portions of the wheel. Other efforts have been made to form the face of a wheel from an alloy and the rim of the wheel from a composite material. Joining the alloy to the composite has not proven viable for a commercial application because fastener and complex joining features that have been employed have not yet proven viable. Efficient and durable methods of affixing a face or central portion of a wheel formed from an alloy to a composite rim portion have proven elusive.

Adjoining the central portion to the composite rim portion in an inexpensive, yet durable manner is believed to be a requisite to broad commercialization of alloy composite road wheels. Therefore, it would be desirable to develop a new type of wheel that makes use of combinations of different materials to provide the necessary physical properties and reduced mass to meet ever increasing performance standards.

### SUMMARY

A road wheel for a vehicle includes a central portion defining a wheel axis and that is formed from a first material. The central portion includes a plurality of spokes extending radially outwardly from lug member with each of the spokes being interconnected to a link disposed at a distal end of the spokes. A rim portion is formed from a second material and defines a tubular wall that is coaxial with the wheel axis. The rim portion defines an interlock that engages the link for interconnecting the central portion with the rim portion.

The concept of a two material wheel is disclosed in co-pending U.S. Provisional patent application Ser. No. 15/422,627 filed on Feb. 2, 2017, the contents of which are included here by reference. It is desirable that the first material provide requisite stiffness while the second material provides mass reduction while providing structural integrity. Further advancements in the interaction between the central portion and the rim portion are disclosed in the present application. The concept of molding an interlock over a link disposed upon the central portion is believed to further enhance the integrity of the road wheel formed from the first material and complimentary second material. Alternatively, encapsulating a link received by a pre-formed interlock in an immovable manner that prevents circumferential displacement of the central portion from the rim portion without the addition of complex fastening techniques advances the cause of commercialization of hybrid, alloy composite wheels.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 shows a plan view of the wheel of the present invention;

FIG. 2 shows a cross-sectional view through a spoke of the wheel of the present invention;

FIG. 3 shows a first embodiment of a central portion of the wheel of the present invention;

FIG. 4 shows a partial cross-sectional of view through a link and spoke of the first embodiment;

FIG. 5 shows a plan view of a second embodiment of the central portion;

FIGS. 6 and 7 show perspective views of a further embodiment of the central portion and link;

FIG. 8 shows a still further embodiment of the central portion and link; and

FIG. 9 shows a still further embodiment with a cover member concealing the link and the interlock.

### DETAILED DESCRIPTION

Referring to FIG. 1, a perspective view of a wheel of the present invention is generally shown at 10. The wheel 10 includes a central portion 12 and a rim portion 14. The central portion 12 defines a wheel axis a around which the wheel 10 rotates in a conventional manner A plurality of spokes 16 extends radially outwardly from a lug member 15 defined by the central portion 12 converging proximate the axis a. As such, the lug member 15 interconnects the spokes 16 proximate the axis a. A plurality of lug apertures 18 are disposed between the axis a and the spokes 16 that are defined by the lug member 15 configured to receive lugs to secure the wheel 10 to a wheel axle (not shown) in a known manner

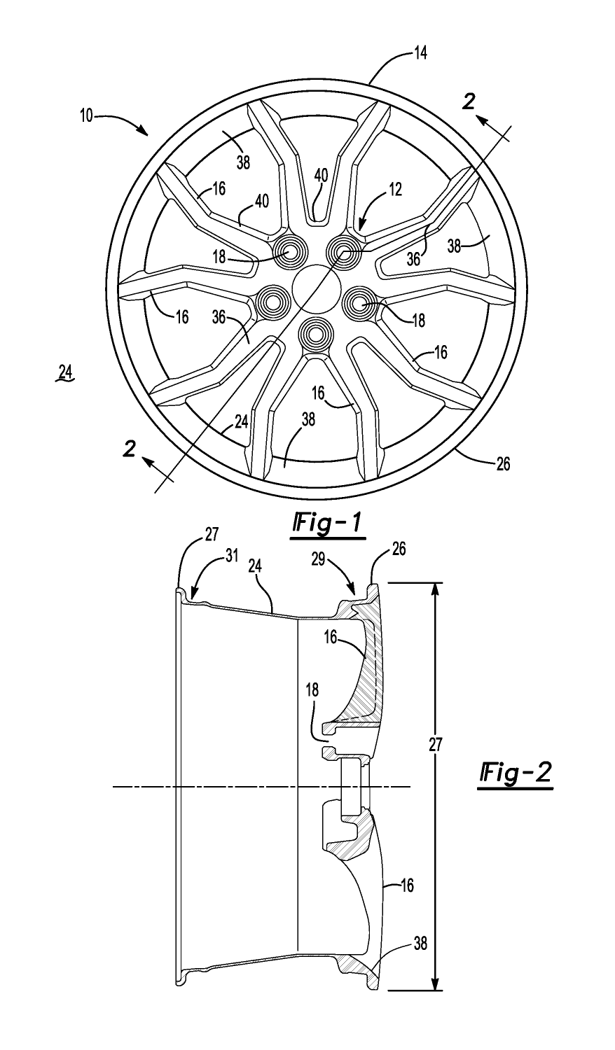

As best represented in FIG. 2, which shows a first embodiment with each spoke 16 extending to a distal end 20 terminating at a link 22, the purpose of which will be explained further herein below. The central portion 12, including the spoke 16 and link 22, are formed from a metallic alloy such as, for example, an aluminum alloy, a magnesium alloy, or other alloy known to provide structural integrity required of the spokes 16, including low mass and desired aesthetic properties. The spoke 16 configuration may be conventional or optimized for reduction of mass as disclosed in U.S. Pat. No. 9,815,323 and co-pending U.S. patent application Ser. No. 15/811,068, the contents each of which are incorporated herein by reference.

Referring again to FIG. 1, the rim portion 14 defines a tubular wall 24 that circumscribes the wheel axis a. The rim portion 14 defines a outer bead element 26 and an inner bead element 27 that is spaced from the outer bead element 26 by the tubular wall 24. It should be known to those of ordinary skill in the art that the outer bead element 26 defines an outer bead seat 29 and the inner bead element 27 defines an inner bead seat 31, each of which receive a mating portion of a tire (not shown) to provide a proper seal for retaining air pressure within a chamber defined between the tire and the wheel 10. Therefore, a seal is formed between the wheel 10 and the tire entirely by the interface between the composite material defining the rim portion 14 and the tire.

The rim portion 14, including the tubular wall 24 and outer bead element 26 and inner bead element 27 are formed completely from a reinforced polymeric material. In one embodiment, the reinforced polymeric material is a thermoplastic ribbon infused with carbon fiber, carbon powder, other fiber glass, or other reinforcing component to provide a structural composite believed to withstand the rigors of a road wheel as is disclosed in co-pending U.S. patent application Ser. No. 15/422,627, the contents of which are incorporated herein by reference. Other polymeric materials are included within the scope of this invention, including, but not limited to two component materials such as, for example, urethanes or other materials capable of withstanding the rigors of a road wheel. Thermoset resins and the use of autoclave curing methods are also within the scope of the invention.

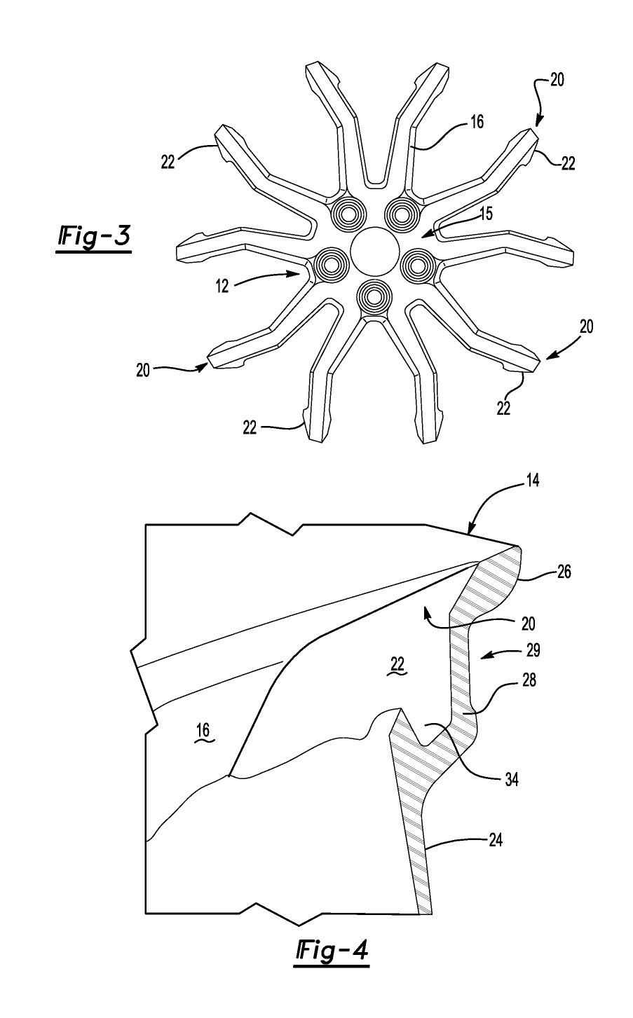

Referring now to FIG. 3, the rim portion 14 defines an interlock 28 that is receives the link 22 disposed at a distal end 20 of each spoke 16. In one embodiment, the link 22 defines a foot 23 that is received by the interlock 28. In this embodiment, the interlock 28 takes the form of a pocket or seat having a complementary design for receiving the foot 23. Therefore, the foot 23 is disposed in an abutting relationship with the interlock 28 for preventing circumferential movement of the central portion 12 relative to the rim portion 14. The interlock 28 fully, or substantially, encapsulates the link 22 to secure the rim portion 14 to the central portion 12.

To achieve encapsulation, the rim portion 14, and more specifically, the interlock 28 may also be molded, or formed over the link 22. In one embodiment, the link 22 is molded integrally with the central portion 12 during normal or conventional manufacturing processes (e.g. casting, forming, machining, etc.) and inserted into a die used for forming the rim portion 14 so that the rim portion 14 is formed over the link 22. An alternative embodiment includes the rim portion 14 being pre-formed with the pocket into which the link 22 is inserted during final assembly. A still further embodiment includes the rim portion 14 being formed as a continuous, or semi continuous sheet that is rolled over the central portion 12 to engage the links 22 and subsequently or simultaneously formed. Heat treating gluing, laser welding and other equivalent methods of attachment for mating sections of the rim portion 14 or even affixing the rim portion 14 to the central portion 12 are within the scope of this invention.

In one embodiment, fibrous materials (not shown) are selected to enforce the composite defining the rim portion 14. It is contemplated that the fibers are encapsulated in a polymeric tape as disclosed in co-pending U.S. patent application Ser. No. 15/422,627. A preform of the rim portion 14 is then laid over the link 22 and the rim portion 14 is inserted into a die cavity for molding or reshaping.

Alternatively, the fibrous materials are laid into a die cavity into which the central portion 14 is inserted in a manner in which each foot 34 is received by the fibrous materials and the rim portion 14 is molded to encapsulate both the foot 34 of the central portion and the fibrous materials. It should further be understood that the fibrous materials or other reinforcing materials may include variable density providing increase amounts of materials where further structural support is desired. For example, a higher density of fibrous materials may be included in the bead elements 26, 27 where additional structural integrity is required and a lower density of fibrous materials may be included in the annular wall 24 where less structural integrity is required.

FIG. 4 shows an alternative embodiment of the central portion wherein like element numbers to the first embodiment are included, but in the 100 series. In the alternative embodiment, each spoke 116 extends radially outwardly away from the axis a to a hoop 132 that interconnects the distal ends 120 of each spoke 116. Lug apertures 118 are disposed in the lug member 115 between the spokes 116 and the axis a to receive lugs (not shown) for affixing the wheel 10 to an axle of a vehicle in a known manner In this embodiment, the link 130 is fully encapsulated within the interlock 28 (FIG. 3) providing enhanced surface area of contact between the link 130 and interlock 28. The alternative central portion 112 is formed from a metal alloy as set forth above. In addition, the foot 134 of the link 130 is encapsulated in the rim portion 14, which is formed over the link 130, as is also set forth above.

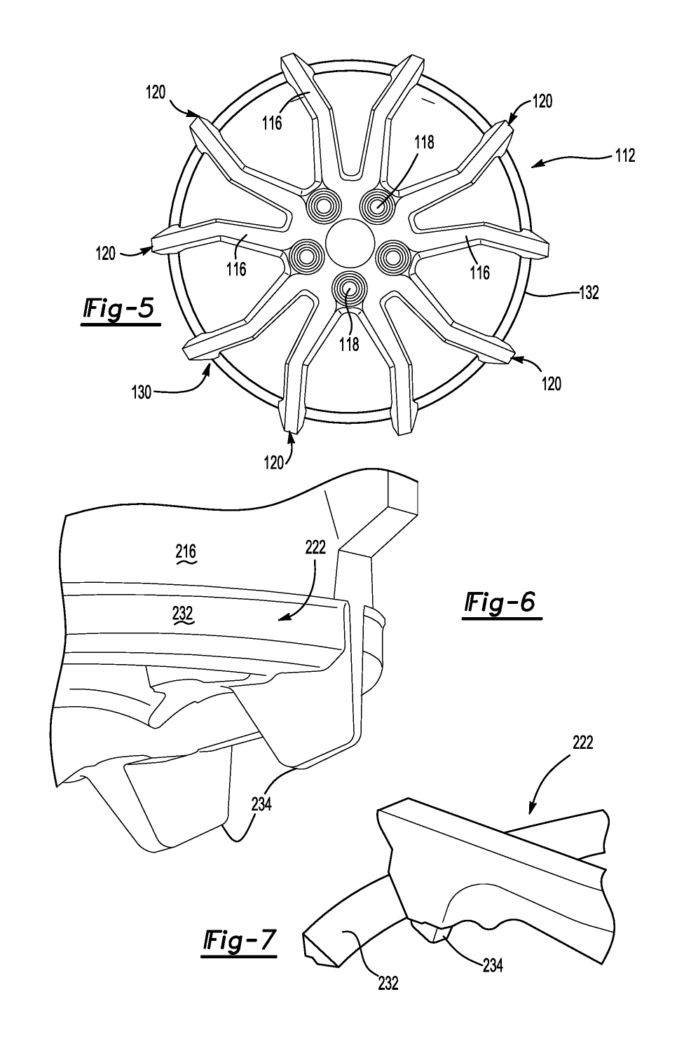

Referring now to FIGS. 5 and 6, wherein like element numbers to prior embodiments are shown in the 200 series, an alternative link is generally shown at 222. In this embodiment, the link 222 includes a hoop 232 interconnecting each spoke 216. Each spoke 216 also includes a foot 234 so that the link 222 includes both a hoop 232 and a foot 234. As set forth above, the link 222, including the hoop 232, is fully, or substantially, encapsulated by the interlock 28 in a manner as is represented in FIG. 3. Therefore, even further surface area is available for the link 22 to engage the interlock 28.

Referring again to FIG. 1, aesthetic qualities are now addressed unique to the wheel 10 of the present invention. Each spoke 16 includes a bright, machine face 36. The face 36 is painted in a known manner to provide gloss and durability characteristics desirable of a high quality wheel 10. In addition, the rim portion 14 defines a rim face 38 that optionally receives a clear coat to highlight the unique characteristics of a composite substrate desirable of the high quality wheel 10 of the present invention. The central portion 12 is optionally painted prior to being mated with the composite rim portion 14. Alternatively, the central portion 12 is partially coated where color is desirable, such as, for example, on recessed surfaces 40. Subsequently, the central portion 12 is mated to the rim portion 14 and the entire wheel 10 receives a clear coat to provide desirable gloss having consistent appearance between the central portion 12 and the rim portion 14. It should be understood that any coating application providing desired esthetic and durability requirements are within the scope of this invention including PVD coatings applied to one of or both the central portion 12 and the rim portion 14. Powder coating, solvent and water base coating, autophoretic coatings, multi-layer and single layer coatings are all within the scope of the invention.

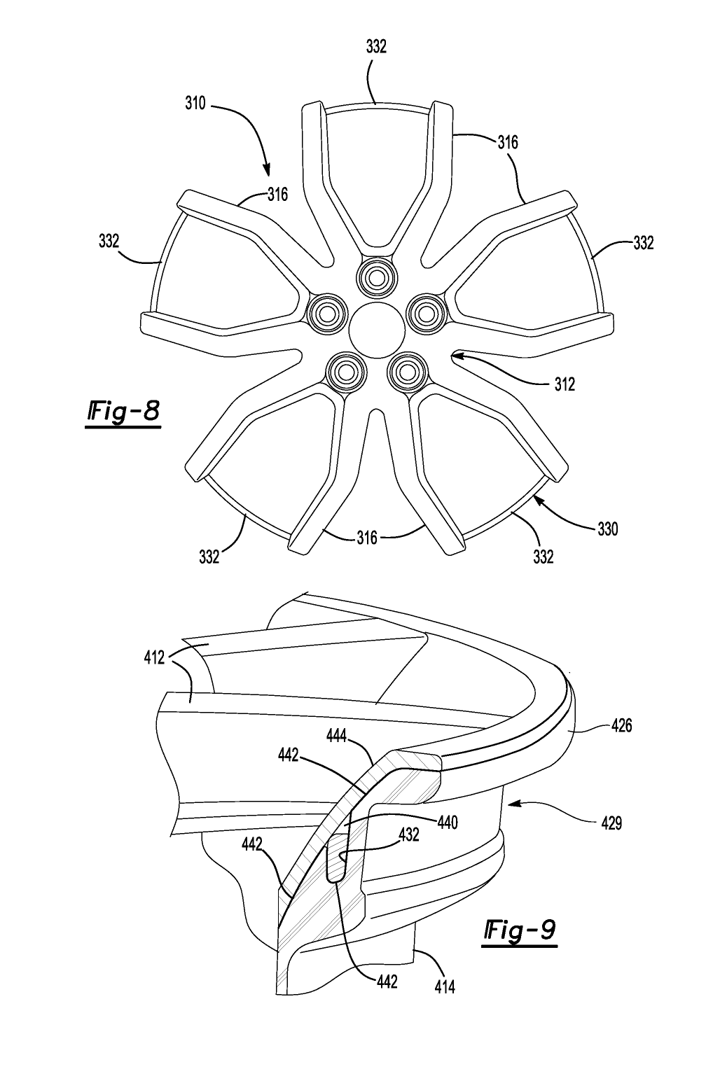

A still further embodiment is shown in FIG. 7 wherein like element numbers to like elements of prior embodiments are shown in the 300 series. In this further embodiment, the central portion 312 includes a plurality of spokes 316 extending radially outwardly away from the axis a. An interrupted link 330 in the form a partial hoop 332 interconnects only some of the spokes 316 rather than all of the spokes as disclosed in an earlier embodiment. Intermittent adjacent spokes 316, or series of spokes 316 are interconnected by the partial hoop 332 depending upon the desired amount of stiffness of the wheel 310. By only interconnecting some of the spokes 316, the mass of the wheel 310 can be optimized along with the desired or requisite stiffness.

A still further embodiment is shown in FIG. 8, wherein like elements to prior embodiments include like element numbers, but in the 400 series. In this embodiment, an outer bead element 426 of a rim portion 414 defines a pocket 440 into which a hoop 432 defined by a link 422 of the central portion 412 is received. Adhesive 442 retains the hoop 432 in the pocket 440. An annular cover member 444 formed from the composite material used to form the rim portion 414 overlays the outer bead element 426 for concealing the hoop 412 and the pocket 440. The cover member 444 is adhered to the bead outer bead element 426 with the adhesive 442. The cover member 444 provides a decorative façade that may be coated in a manner that is complementary to the finish of the face element 412 and spokes 416.

In another embodiment, the cover member 444 also provides structural support to the rim portion 414 or includes a higher or lower density depending upon structural and mass requirements. In addition, the cover member 444 exclude encapsulated fibrous materials for lower mass or include fibrous materials for increased structural properties. In still a further embodiment, the cover member 444 is formed from a different composite material from the rim portion 414 to provide either distinguishing visible features or even enhanced structural support. The cover member 444 may also be painted in manner offering further distinguishing features, such as, for example, a clear coat to highlight the fibrous nature of the cover member 444 substrate.

Obviously, many modifications and variations of the present invention are possible in light of the above teachings. The foregoing invention has been described in accordance with the relevant legal standards; thus, the description is merely exemplary other than limiting in nature. Variations and modifications to the disclosed embodiment may become apparent to those skilled in the art and do come within the scope of this invention. Accordingly, the scope of a legal protection afforded this invention can only be determined by studying the following claims.

What is claimed is:

1. A road wheel for a vehicle, comprising:
a central portion defining a wheel axis and being formed from a first material and including a plurality of spokes extending radially outwardly from said central portion, each of said spokes being interconnected to a link disposed at a distal end of said spokes; and
a rim portion formed from a second material and defining a tubular wall being coaxial with said wheel axis, said rim portion including an interlock engaging said link thereby interconnecting said central portion with said rim portion.

2. The road wheel set forth in claim 1, wherein said link defines a foot disposed at said distal end of each of said spokes.

3. The road wheel set forth in claim 1, wherein said link defines a hoop circumscribing said wheel axis and interconnecting each said distal end of said spokes.

4. The road wheel set forth in claim 1, wherein said first material defines a metallic alloy and said second material comprises a polymeric composite.

5. The road wheel set forth in claim 4, wherein said second material comprises a polymeric composite reinforced by at least one of a fibrous material, carbon, glass or an equivalent.

6. The road wheel set forth in claim 1, wherein said second material at least partially encapsulates said link.

7. The road wheel set forth in claim 1, wherein said second material fully encapsulates said link.

8. The road wheel set forth in claim 1, said rim defines an inner bead element and an outer bead element and said link and said interlock are disposed proximate said outer bead element.

9. The road wheel set forth in claim 1, wherein said interlock of said rim defines a face disposed between each of said spokes.

10. The road wheel set forth in claim 1, wherein said link defines a partial hoop interconnecting some of said spokes.

11. The road wheel set forth in claim 2, wherein said foot defines a stop thereby preventing circumferential displacement of said central portion relative to said wheel portion.

12. The road wheel set forth in claim 1, further including a cover member being overlaid upon said link thereby encapsulating said link between said cover member and said rim portion.

13. A method of manufacturing a composite wheel assembly, comprising the steps of:
forming a central portion from an alloy, with said central portion defining a hub portion and a plurality of spokes extending radially outwardly away from said wheel axis with said spokes defining an link being spaced from said wheel axis
forming a rim portion from a composite material with said rim portion defining an annular wall disposed between first and second bead elements with said first bead element defining a seat for receiving said link; and
mating said link to said seat with said link defining an interlocking engagement therebetween for securing said central portion to said rim portion.

14. The method set forth in claim 13, wherein said step of mating said link to said seat defining an interlocking engagement is further defined by said link defining a circumferential abutment with said seat.

15. The method set forth in claim 13, wherein said step of mating said link to said seat defining an interlocking engagement is further defined by adhering said link to said seat with an adhesive.

16. The method set forth in claim 13, further including step of concealing said link with a cover member.

17. The method set forth in claim 13, further including the step of adhering said cover member over said link with an adhesive.

18. The method set forth in claim 13, further including the step of forming a preform of said rim portion and reforming said preform on said link thereby securing said central portion to said rim portion.

19. The method set forth in claim 13, further including the step of interconnecting at least some of said spokes with a hoop.

20. The method set forth in claim 13, further including the step of applying a clear coating paint to said wheel assembly after said central portion has been secured to said rim portion.
